(19) United States
(12) Patent Application Publication
(10) Pub. No.: US 2016/0136578 A1
(43) Pub. Date: May 19, 2016

(54) FLOW CONTROL IN MULTI-STEP FILTRATION, AND ASSOCIATED SYSTEMS

(71) Applicant: Massachusetts Institute of Technology, Cambridge, MA (US)

(72) Inventors: Ronan K. McGovern, Cambridge, MA (US); John H. Lienhard, V, Lexington, MA (US)

(73) Assignee: Massachusetts Institute of Technology, Cambridge, MA (US)

(21) Appl. No.: 14/943,945

(22) Filed: Nov. 17, 2015

Related U.S. Application Data
(60) Provisional application No. 62/080,696, filed on Nov. 17, 2014.

(51) Int. Cl. B01D 61/02; C12H 1/07; B01D 61/08

(52) U.S. Cl. CPC B01D 61/022; B01D 61/08; C12H 1/063; B01D 2311/25; B01D 2313/50

(57) ABSTRACT

Flow control in multi-step filtration systems and associated methods are generally described. Certain embodiments are related to methods in which a single filter is used to perform multiple, separate filtration steps. In some cases, a diluted permeate from a first filtration step can be recycled back through the filter, as part of a separate filtration step, to produce a second retentate and a second permeate. Subsequent filtration steps can also be performed. Systems configured to perform multiple, separate filtration steps using a single filter are also described.

### RELATED APPLICATIONS

This application claims priority under 35 U.S.C. §119(e) to U.S. Provisional Patent Application Ser. No. 62/080,696, filed Nov. 17, 2014 and entitled “Flow Control in Multi-Step Filtration, and Associated Systems,” which is incorporated herein by reference in its entirety for all purposes.

### TECHNICAL FIELD

Filtration systems and associated methods are generally described.

### BACKGROUND

Separation of components within an initial mixture is a common task performed in a number of industries. Filtration is one method that can be used to perform such separations. Filtration systems have been employed in which an inlet stream containing a mixture of two or more components is transported over a filtration medium to produce a first stream transported through the filter (generally referred to as a permeate stream, which is enriched in the component that is more readily transported through the filtration medium) and a second stream that is not transported through the filter (generally referred to as a retentate stream, which is enriched in the component that is less readily transported through the filtration medium).

It can be challenging, in some instances, to achieve effective separation of components within an initial mixture using filtration systems. For example, one challenge faced in the beer industry is effectively using filtration-based systems to concentrate beer, as ethanol is generally less effectively filtered from water than dissolved salts. In addition, current commercial processes for concentrating such mixtures are generally inefficient from both an energy and capital cost standpoint.

Improved systems and methods for performing filtration are therefore desirable.

### SUMMARY

Flow control in multi-step filtration systems and associated methods are generally described. Certain embodiments comprise using a single filter to perform a multi-step filtration process. The subject matter of the present invention involves, in some cases, interrelated products, alternative solutions to a particular problem, and/or a plurality of different uses of one or more systems and/or articles.

According to certain embodiments, a method of concentrating a minor component of a mixture is provided. The method comprises, in some embodiments, establishing a hydraulic pressure differential across a filtration medium within a filter receiving a liquid feed comprising a major component and a minor component to produce a first permeate enriched in the major component relative to the liquid feed and a first retentate enriched in the minor component relative to the liquid feed; subsequently, separately from the first hydraulic pressure differential establishing step, transporting at least a portion of the first permeate to the filter; and establishing a hydraulic pressure differential across the filtration medium within the filter receiving the portion of the first permeate to produce a second permeate enriched in the major component relative to the first permeate and a second retentate enriched in the minor component relative to the first permeate.

Certain embodiments are related to a system for concentrating a minor component of a mixture. The system comprises, in some embodiments, a first vessel; a second vessel; a filter comprising a filtration medium defining a permeate side and a retentate side of the filter; a fluidic pathway between the first vessel and the retentate side of the filter; a fluidic pathway between the second vessel and the permeate side of the filter; and a fluidic pathway between the second vessel and the retentate side of the filter.

According to certain embodiments, the method comprises establishing a hydraulic pressure differential across a filtration medium within a filter receiving a liquid feed comprising a major component and a minor component to produce a first permeate enriched in the major component relative to the liquid feed and a first retentate enriched in the minor component relative to the liquid feed, and transporting at least a portion of the first permeate to a vessel, wherein the weight percentage of the minor component increases monotonically as a function of height within the vessel from a region containing the minor component at a first weight percentage to a region containing the minor component at a second weight percentage that is higher than the first weight percentage.

The method comprises, in some embodiments, establishing a hydraulic pressure differential across a filtration medium within a filter receiving a liquid feed comprising a major component and a minor component to produce a first permeate enriched in the major component relative to the liquid feed and a first retentate enriched in the minor component relative to the liquid feed, and transporting at least a portion of the first retentate to a vessel, wherein the weight percentage of the minor component increases monotonically as a function of height within the vessel from a region containing the minor component at a first weight percentage to a region containing the minor component at a second weight percentage that is higher than the first weight percentage.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is an exemplary schematic illustration of a filter, which may be used in association with certain embodiments described herein;

FIG. 2 is, according to certain embodiments, a schematic illustration of a filtration system;

FIG. 3 is a cross-sectional schematic illustration of an exemplary vessel, according to certain embodiments; and

FIG. 4 is a schematic illustration of an exemplary filtration system, according to one embodiment.

### DETAILED DESCRIPTION

Flow control in multi-step filtration systems and associated methods are generally described. Certain embodiments are related to methods in which a single filter is used to perform multiple, separate filtration steps. In some such embodiments, a diluted permeate from a first filtration step can be recycled back through the filter, as part of a separate filtration step, to produce a second retentate and a second permeate. Subsequent filtration steps can also be performed. Certain embodiments are related to systems configured to perform multiple, separate filtration steps using a single filter.

Certain of the embodiments described herein can be used in filtration systems and/or methods in which the filtration medium is permeable to multiple components in the inlet mixture. As one non-limiting example, reverse osmosis membranes are typically at least partially permeable to ethanol, in addition to water. Accordingly, in some such cases, when mixtures comprising water and ethanol are processed using reverse osmosis systems, both ethanol and water are transported through the reverse osmosis membrane, leading to incomplete separation of the ethanol from the permeate water. This behavior is in contrast to the behavior typically observed in reverse osmosis systems in which dissolved salts are separated from solvents (e.g., water), in which substantially complete separation between permeate water and dissolved salt is often achieved. Incomplete filtration of ethanol from water can lead to challenges in producing concentrates of ethanol-containing mixtures (e.g., beer, wine, liquor, and the like). Certain, although not necessarily all, of the embodiments described herein can be advantageously employed in certain such systems to reduce the amount of filtration medium surface area that is needed to perform a desired concentration process, as described in more detail below.

Certain embodiments involve using filters to concentrate a minor component of a liquid feed comprising the minor component and a major component. The term “major component” is generally used herein to describe the most abundant component—by weight percentage (wt %)—of a mixture within a liquid feed. “Minor components” are all components of the mixture that are not the major component.

In some embodiments, there is a single minor component in the mixture of the liquid feed. For example, in a mixture that is 60 wt % water and 40 wt % ethanol, water would be the major component and ethanol would be the (single) minor component.

In other embodiments, multiple minor components may be present in the mixture of the liquid feed. For example, in a mixture that is 45 wt % water, 30 wt % ethanol, and 25 wt % methanol, water would be the major component, and ethanol and methanol would both be minor components.

According to certain embodiments, the liquid feed can contain a “target minor component.” Generally, the target minor component corresponds to the minor component within the liquid feed that the filtration system is configured to concentrate. In liquid feeds containing only a major component and a minor component, the target minor component is—by default—the single minor component. In cases where the feed stream comprises multiple minor components, any of the minor components can be the target component. In certain embodiments, the target minor component corresponds to the second most abundant component in the liquid feed, by weight percentage (which corresponds to the most abundant of the minor components in the liquid feed, by weight percentage). For example, in some embodiments, the liquid feed comprises water as the major component, ethanol as the most abundant minor component, and an additional minor component that is less abundant than ethanol, and the target minor component is ethanol.

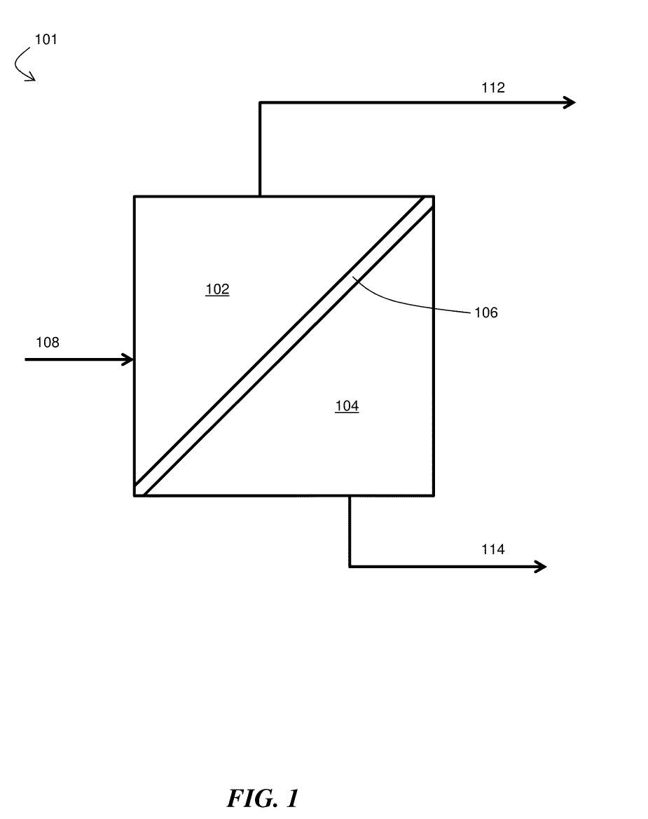

As described in more detail below, a variety of suitable filters can be used in association with the systems and methods described herein. FIG. 1 is a cross-sectional schematic illustration of an exemplary filter 101, which can be used in association with certain of the embodiments described herein. Filter 101 comprises filtration medium 106. The filtration medium can define a permeate side and a retentate side of the filter. For example, in FIG. 1, filtration medium 106 separates filter 101 into retentate side 102 (to which the incoming liquid feed is transported) and permeate side 104. The filtration medium can allow at least one component (e.g., the major component) of an incoming liquid feed (which can contain a mixture of a major component and at least one minor component) to pass through the filtration medium to a larger extent that at least one other component (e.g., a minor component, such as the target minor component) of the incoming liquid mixture.

During operation, a hydraulic pressure differential can be established across the filtration medium within the filter. The hydraulic pressure differential can be established across the filtration medium such that the gauge pressure on the retentate side of the filter (P_{R}) exceeds the gauge pressure on the permeate side of the filter (P_{P}). In some cases, a hydraulic pressure differential can be established across the filtration medium by applying a positive pressure to the retentate side of the filter. For example, referring to FIG. 1, a hydraulic pressure differential can be established across filtration medium 106 by applying a positive pressure to retentate side 102 of filter 101. The positive pressure can be applied, for example, using a pump, a pressurized gas stream, or any other suitable pressurization device. In some cases, a hydraulic pressure differential can be established across the filtration medium by applying a negative pressure to the permeate side of the filter. Referring to FIG. 1, for example, a hydraulic pressure differential can be established across filtration medium 106 by applying a negative pressure to permeate side 104 of filter 101. The negative pressure can be applied, for example, by drawing a vacuum on the permeate side of the filter. In some cases, the applied hydraulic pressure differential within the filter can vary spatially. In some such embodiments, the applied hydraulic pressure differential within the filter is uniform within 5 bar.

Establishing a hydraulic pressure differential across the filtration medium can produce a first permeate enriched in the major component relative to the liquid feed and a first retentate enriched in a minor component (e.g., the target minor component) relative to the liquid feed. For example, in FIG. 1, a liquid feed containing a major component and a minor component (e.g., the target minor component) can be transported to filter 101 via liquid feed 108. In certain embodiments, a hydraulic pressure differential can be established across filtration medium 106 such that the hydraulic pressure decreases from retentate side 102 of filter 101 to permeate side 104 of filter 101. The established hydraulic pressure differential across the filtration medium (ΔP_{E}) can be expressed as:

ΔP_{E}=P_{R}−P_{P}

where P_{R} is the gauge pressure on the retentate side of the filter and P_{P} is the gauge pressure on the permeate side of the filter. Generally, the liquid mixtures in the filter will each have an osmotic pressure associated with them. For example, the liquid on the retentate side of the filter will generally have an osmotic pressure π_{R}, and the liquid of the permeate side of the filter will generally have an osmotic pressure π_{P}. Accordingly, the osmotic pressure differential across the filtration medium (Δπ) can be expressed as:

Δπ=π_{R}−πₚ

In certain embodiments, when the established hydraulic pressure differential across the filtration medium exceeds the osmotic pressure differential across the filtration medium, one or more components of the liquid feed is transported across the filtration medium. Such behavior is known to those familiar with the phenomenon of reverse osmosis.

In practice, the filtration methods, according to certain embodiments, can proceed by supplying a liquid mixture that is relatively dilute in the target minor component to retentate side 102 of filter 101. Retentate side 102 of filter 101 can have a gauge pressure (P_{R}) sufficiently in excess of the gauge pressure (P_{P}) on permeate side 104 of filter 101 to force at least a portion of the major component through filtration medium 106 while retaining a sufficient amount of the target minor component on retentate side 102 such that the concentration of the target minor component on retentate side 102 of filter 101 increases above the concentration of the target minor component within liquid feed 108. In FIG. 1, for example, establishing the hydraulic pressure differential across filtration medium 106 can produce first permeate 114 enriched in the major component relative to liquid feed 108 and first retentate 112 enriched in a minor component (e.g., the target minor component) relative to liquid feed 108. The filtration process can be continued until a desired concentration of the target minor component is achieved.

In many traditional pressure-based filtration systems (such as reverse osmosis systems), the transport of minor components through the filtration medium is limited such that a high degree of separation is achieved between the major component and the minor component(s) of the liquid mixture fed to the filter. Such systems are said to achieve high rejection levels of the minor component(s). The rejection level of a particular filtration medium with respect to a particular minor component can be expressed as a percentage (also referred to herein as a “rejection percentage,” described in more detail below).

While the filtration media of many salt-based filtration systems are capable of achieving high rejection percentages during operation, filtration media of filtration systems used to concentrate other types of minor components frequently cannot achieve such high rejection percentages. For example, when non-charged, low molecular weight compounds such as ethanol are used as minor components, rejection percentages can be quite low. Thus, relatively large amounts of such minor components can be transported—along with the major component—through the filtration medium during operation. This leads to relatively poor separations and can make it difficult to achieve high concentrations of the minor component in the retentate stream without producing substantial amounts of wasted minor component in the permeate stream.

One way to recover minor component(s) that have been transferred through the filtration medium is to subject the permeate stream to further filtration to produce additional retentate and permeate streams. However, such strategies often require a large number of filters, and are therefore complicated and expensive to implement.

Certain embodiments of the present invention are related to the recognition that systems including a single filter can be configured and/or operated in a manner such that ethanol that is transported through the filtration medium in the first filtration step can be recovered in subsequent filtration steps performed using the same filter. By using a single filter to perform multiple, temporally independent filtration steps, one can reduce the overall number of filters needed to achieve a desired concentration level of the minor component while reducing the amount of minor component that is wasted.

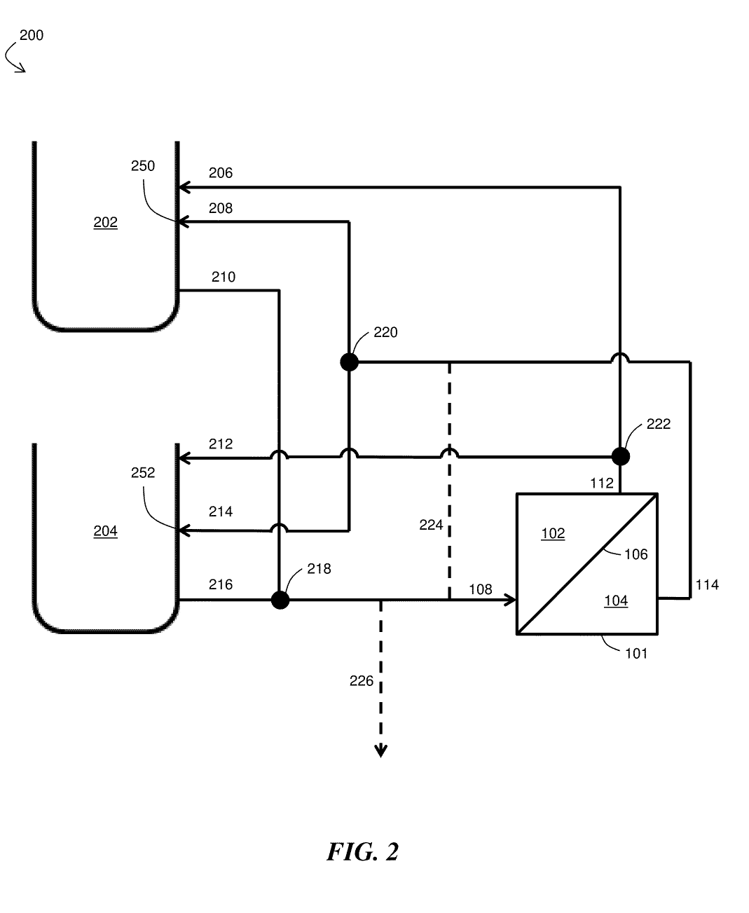

As noted above, certain embodiments are related to systems for concentrating a minor component of a mixture. The system can be configured, according to some embodiments, such that a single filter is used to perform multiple passes of a filtration process. FIG. 2 is a schematic illustration of one such exemplary filtration system 200.

In certain embodiments, the filtration system comprises a filter comprising a filtration medium defining a permeate side and a retentate side of the filter. For example, in the exemplary embodiment of FIG. 2, system 200 comprises filter 101. Filter 101 comprises filtration medium 106 defining permeate side 104 of filter 101 and retentate side 102 of filter 101.

The filtration system can also comprise, in some embodiments, a first vessel. For example, in FIG. 2, system 200 comprises first vessel 202. In some embodiments, the filtration system comprises a fluidic pathway between the first vessel and the retentate side of the filter. For example, in FIG. 2, system 200 comprises streams 210 and 108, which form a fluidic pathway between retentate side 102 of filter 101 and first vessel 202. The fluidic pathway between the first vessel and the retentate side of the filter can allow one to transport a liquid feed stream from the first vessel to the filter for subsequent filtration.

In certain embodiments, prior to the production of the first permeate, the liquid feed can be contained within a vessel (e.g., first vessel 202), also sometimes referred to herein as the “liquid feed vessel.” In some such embodiments, prior to the production of the first permeate, the weight percentage of at least one (or all) of the minor components (e.g., the target minor component, or any other minor component) within the liquid feed contained within the liquid feed vessel is substantially homogeneous. The weight percentage of a component is said to be substantially homogeneous within a given volume when the weight percentage of the component—over at least about 95% of the space occupied by the volume—is between about 0.9 and about 1.1 times the average weight percentage of that component within the volume. The average weight percentage of a component within a volume is calculated by dividing the mass of the component within the volume by the total mass of the volume. In certain embodiments in which a weight percentage of a component is substantially homogeneous within a given volume, the weight percentage of the component—over at least about 98%, or at least about 99% of the space occupied by the volume, or within all of the space occupied by the volume—is between about 0.9 and about 1.1 times the average weight percentage of that component within the volume. In some embodiments in which a weight percentage of a component is substantially homogeneous within a given volume, the weight percentage of the component—over at least about 95%, at least about 98%, or at least about 99% of the space occupied by the volume, or within all of the space occupied by the volume—is between about 0.95 and about 1.05, between about 0.98 and about 1.02, or between about 0.99 and about 1.01 times the average weight percentage of that component within the volume.

The filtration system comprises, according to some embodiments, a second vessel. For example, in FIG. 2, system 200 comprises second vessel 204. The second vessel may be used, according to certain embodiments, to store the permeate produced during the filtration of an initial liquid feed for filtration in a subsequent, separate step. Accordingly, in some embodiments, the system comprises a fluidic pathway between the second vessel and the permeate side of the filter. Referring to FIG. 2, for example, filtration system 200 comprises streams 114 and 214, which form a fluidic pathway from permeate side 104 of filter 101 to second vessel 204. According to some embodiments, streams 114 and 214 can be used to transport permeate from filter 101 to second vessel 204, for example, for storage.

In some embodiments, the filtration system comprises a fluidic pathway between the second vessel and the retentate side of the filter. For example, referring to FIG. 2, system 200 comprises streams 216 and 108, which form a fluidic pathway from second vessel 204 to retentate side 102 of filter 101. According to certain embodiments, streams 216 and 108 can be used to transport liquid from second vessel 204 (e.g., the permeate from the filtration of the original contents of vessel 202) to filter 101 for subsequent filtration.

In some embodiments, the filtration system also comprises a fluidic pathway between the first vessel and the permeate side of the filter. For example, in FIG. 2, filtration system 200 comprises streams 114 and 208, which form a fluidic pathway between permeate side 104 of filter 101 and vessel 202. According to some embodiments, streams 114 and 208 can be used to transport permeate from filter 101 to first vessel 202, for example, after the liquid feed from vessel 204 has been filtered within filter 101. In some embodiments, after liquid has been transported from permeate side 104 of filter 101 to first vessel 202, the liquid can be transported from first vessel 202 to retentate side 102 of filter 101, for example, via streams 210 and 108. In this way, vessels 202 and 204 can be used as sources of liquid for multiple filtration steps using a single filter (filter 101).

According to certain embodiments, system 200 comprises a second fluidic pathway between the first vessel and the retentate side of the filter. For example, referring to the exemplary embodiment of FIG. 2, system 200 comprises streams 112 and 206, which form a second fluidic pathway from retentate side 102 of filter 101 and first vessel 202. The second fluidic pathway between the retentate side of the filter and the first vessel can be used to create a recirculation pathway between first vessel 202 and retentate side 102 of filter 101. The recirculation pathway can allow one to cycle a liquid mixture multiple times through filter 101 until a desired concentration of the minor component is achieved within first vessel 202.

In some embodiments, system 200 comprises a second fluidic pathway between the second vessel and the retentate side of the filter. For example, referring to the exemplary embodiment of FIG. 2, system 200 comprises streams 112 and 212, which form a second fluidic pathway from retentate side 102 of filter 101 and second vessel 204. The second fluidic pathway between the retentate side of the filter and the second vessel can be used to create a recirculation pathway between second vessel 204 and retentate side 102 of filter 101. The recirculation pathway can allow one to cycle a liquid mixture multiple times through filter 101 until a desired concentration of the minor component is achieved within second vessel 204.

According to certain embodiments, the filtration system can comprise one or more valves, which can be used to direct and/or control liquid flow within the filtration system.

For example, in some embodiments, a valve can be used to switch from a first state in which liquid is transported from the first vessel to the retentate side of the filter (e.g., with no substantial flow from the second vessel to the retentate side) to a second state in which liquid is transported from the second vessel to the retentate side of the filter (e.g., with no substantial flow from the first vessel to the retentate side). In certain embodiments, the fluidic pathway between the first vessel and the retentate side of the filter and the fluidic pathway between the second vessel and the retentate side of the filter are arranged to comprise a fluidic pathway from the first vessel to a valve, a fluidic pathway from the second vessel to the valve, and a fluidic pathway from the valve to the retentate side of the filter. For example, referring to FIG. 2, system 200 comprises valve 218. In FIG. 2, the fluidic pathway between first vessel 202 and retentate side 102 of filter 101 and the fluidic pathway between second vessel 204 and retentate side 102 of filter 101 are arranged to comprise fluidic pathway 210 from first vessel 202 to valve 218, fluidic pathway 216 from second vessel 204 to valve 218, and fluidic pathway 108 from valve 218 to retentate side 102 of filter 101. In some embodiments, valve 218 is a three-way valve. Valve 218 can be configured such that operation of system 200 can be switched between a first state in which liquid is transported from first vessel 202 to retentate side 102 of filter 101 (via streams 210 and 108) and a second state in which liquid is transported from second vessel 204 to retentate side 102 of filter 101 (via streams 216 and 108).

According to certain embodiments, a valve can be used to switch from a first state in which liquid is transported from the permeate side of the filter to the first vessel (e.g., with no substantial flow from the permeate side to the second vessel) to a second state in which liquid is transported from the permeate side of the filter to the second vessel (e.g., with no substantial flow from the permeate side to the first vessel). In certain embodiments, the fluidic pathway between the permeate side of the filter and the first vessel and the fluidic pathway between the permeate side of the filter and the second vessel are arranged to comprise a fluidic pathway from the permeate side of the filter to a valve, a fluidic pathway from the valve to the first vessel, and a fluidic pathway from the valve to the second vessel. For example, referring to FIG. 2, system 200 comprises valve 220. In FIG. 2, the fluidic pathway between first vessel 202 and permeate side 104 of filter 101 and the fluidic pathway between second vessel 204 and permeate side 104 of filter 101 are arranged to comprise fluidic pathway 114 from permeate side 104 of filter 101 to valve 220, fluidic pathway 208 from valve 220 to first vessel 202, and fluidic pathway 214 from valve 220 to second vessel 204. In some embodiments, valve 220 is a three-way valve. Valve 220 can be configured such that operation of system 200 can be switched between a first state in which liquid is transported from permeate side 104 of filter 101 to first vessel 202 (via streams 114 and 208) and a second state in which liquid is transported from permeate side 104 of filter 101 to second vessel 204 (via streams 114 and 214).

In some embodiments, a valve can be used to switch from a first state in which liquid is transported from the retentate side of the filter to the first vessel (e.g., with no substantial flow from the retentate side to the second vessel) to a second state in which liquid is transported from the retentate side of the filter to the second vessel (e.g., with no substantial flow from the retentate side to the first vessel). In certain embodiments, the fluidic pathway between the retentate side of the filter and the first vessel and the fluidic pathway between the retentate side of the filter and the second vessel are arranged to comprise a fluidic pathway from the retentate side of the filter to a valve, a fluidic pathway from the valve to the first vessel, and a fluidic pathway from the valve to the second vessel. For example, referring to FIG. 2, system 200 comprises valve 222. In FIG. 2, the second fluidic pathway between first vessel 202 and retentate side 102 of filter 101 and the second fluidic pathway between second vessel 204 and retentate side 102 of filter 101 are arranged to comprise fluidic pathway 112 from retentate side 102 of filter 101 to valve 222, fluidic pathway 206 from valve 222 to first vessel 202, and fluidic pathway 212 from valve 222 to second vessel 204. In some embodiments, valve 222 is a three-way valve. Valve 222 can be configured such that operation of system 200 can be switched between a first state in which liquid is transported from retentate side 102 of filter 101 to first vessel 202 (via streams 112 and 206) and a second state in which liquid is transported from retentate side 102 of filter 101 to second vessel 204 (via streams 112 and 212).

In some embodiments, the filtration system comprises a permeate bypass stream. For example, referring to the exemplary embodiment of FIG. 2, system 200 comprises permeate bypass stream 224, which fluidically connects stream 114 to stream 108. In certain embodiments, where the concentration of a minor component is non-uniform in vessels 202 or 204, fluid with a lower concentration of the minor component may be transported from one vessel to the other and in doing so bypass filter 101. The benefit of such an operation is that the overall processing time may be shortened, according to certain embodiments, since during the bypass operation fluid can flow from one vessel to the other at a rate much higher than would be possible if it were to pass via the filter. This operation is particularly desirable, in certain but not necessarily all cases, if a portion of the fluid contained in one vessel already contains a minor component concentration that is acceptably low but also contains fluid with a minor component concentration that is above an acceptable level and thus requires filtration. Furthermore, according to certain embodiments, after two steps of filtration, the bypass may be employed to transfer the second retentate into the vessel containing the first retentate.

According to certain embodiments, the filtration system comprises an outlet stream. The outlet stream can be configured, according to certain embodiments, to remove liquid from the filtration system, for example, after desired levels of the target minor component have been achieved and/or after desired minor component concentrations have been reached in the tank with the higher average minor component concentration. Referring to FIG. 2, for example, system 200 comprises outlet stream 226. Outlet stream 226 can be used to remove one or more product streams from system 200 during operation.

Exemplary filtration systems in which a filter is used to perform multiple filtration steps can be operated as follows. Some embodiments comprise establishing a hydraulic pressure differential across a filtration medium within a filter receiving a liquid feed comprising a major component and a minor component (e.g., the target minor component) to produce a first permeate enriched in the major component relative to the liquid feed and a first retentate enriched in the minor component relative to the liquid feed. For example, referring to the exemplary embodiment of FIG. 2, liquid feed stream 108 can be transported to filter 101. In some embodiments, liquid feed stream 108 can originate from first vessel 202. For example, valve 218 can be positioned such that liquid feed from vessel 202 is transported via pathway 210, through valve 218, and to retentate side 102 of filter 101 via stream 108.

A hydraulic pressure differential can be established across filtration medium 106 of filter 101. Establishing the hydraulic pressure differential across filtration medium 106 can result in at least a portion of the major component being transported across filtration medium 106. Accordingly, in some such embodiments, establishing a hydraulic pressure differential across filtration medium 106 can produce permeate 114 which is enriched in the major component relative to liquid feed 108. In addition, establishing a hydraulic pressure differential across filtration medium 106 can produce retentate 112 which is enriched in a minor component (e.g., the target minor component) relative to liquid feed 108.

In certain embodiments, during the filtration step, the liquid fed to the retentate side of the filter can be recirculated between the first vessel and the retentate side of the filter. Such recirculation can be performed, for example, to ensure that the resulting retentate liquid has a desired amount of one or more minor components (e.g., the target minor component). Referring to FIG. 2, for example, in some embodiments, liquid feed from vessel 202 can be transported to retentate side 102 of filter 101 via streams 210 and 108, after which the retentate may be transported back to first vessel 202 via streams 112 and 206 (e.g., by switching valve 222 to and/or maintaining valve 222 in an appropriate position). In some such embodiments, the liquid that is transported back to first vessel 202 can be subsequently transported back to retentate side 102 of filter 101 for further filtration. In some embodiments, liquid can be recirculated between vessel 202 and retentate side 102 of filter 101 until the concentration of the minor component (e.g., the target minor component) within the recirculated liquid reaches a desired level.

Some embodiments comprise subsequently, and separately from the first hydraulic pressure differential establishing step, transporting at least a portion (e.g., at least about 10 wt %, at least about 25 wt %, at least about 50 wt %, at least about 75 wt %, at least about 90 wt %, at least about 95 wt %, at least about 99 wt %, or all) of the first permeate to the filter. For example, in some embodiments, permeate 114, produced during the first filtration step, can be recycled back to retentate side 102 of filter 101 in a step that is separate from the transportation of the initial liquid feed 108.

Certain embodiments comprise establishing a hydraulic pressure differential across the filtration medium within the filter receiving the portion of the first permeate to produce a second permeate enriched in the major component relative to the first permeate and a second retentate enriched in the minor component relative to the first permeate. For example, referring to FIG. 2, in some embodiments, at least a portion (e.g., at least about 10 wt %, at least about 25 wt %, at least about 50 wt %, at least about 75 wt %, at least about 90 wt %, at least about 95 wt %, at least about 99 wt %, or all) of the permeate produced during the initial filtration step can be transported to retentate side 102 of filter 101. A hydraulic pressure differential can be established across filtration medium 106 of filter 101 to produce a second permeate enriched in the major component relative to the first permeate and a second retentate enriched in the minor component relative to the first permeate.

The step of establishing a hydraulic pressure differential across the filtration medium when the filter contains the first permeate can be temporally separate from the step of establishing a hydraulic pressure differential across the filtration medium when the filter contains the initial liquid feed transported to filter 101 (e.g., from first vessel 202). For example, in some embodiments, the initial liquid feed (e.g., from first vessel 202) can be transported to filter 101, and a hydraulic pressure differential can be established across filtration medium 106 to produce a first permeate. In some such embodiments, flow of the initial liquid feed (e.g., from the first vessel) can be stopped or substantially stopped, after which at least a portion (e.g., at least about 10 wt %, at least about 25 wt %, at least about 50 wt %, at least about 75 wt %, at least about 90 wt %, at least about 95 wt %, at least about 99 wt %, or all) of the first permeate can be transported to retentate side 102 of filter 101. A hydraulic pressure differential may then be established across filtration medium 106 of filter 101 to produce a second retentate and a second permeate from the portion of the first permeate.

According to certain embodiments, during and/or after the first hydraulic pressure differential establishing step and before the second hydraulic pressure differential establishing step, at least a portion (e.g., at least about 10 wt %, at least about 25 wt %, at least about 50 wt %, at least about 75 wt %, at least about 90 wt %, at least about 95 wt %, at least about 99 wt %, or all) of the first permeate is transported to a vessel. In some such embodiments, the step of transporting at least a portion of the first permeate to the filter occurs after the step of transporting at least a portion of the first permeate from the filter (e.g., from the permeate side of the filter) to the vessel. For example, in some embodiments, at least a portion of the first permeate can be transported from the permeate side of the filter to the vessel. In some such embodiments, the portion of the permeate can be stored in the vessel until the second filtration step is performed. For example, referring to FIG. 2, during and/or after the filtration of the initial feed liquid (e.g., the liquid initially contained in first vessel 202), permeate 114 can be transported to second vessel 204 via streams 114 and 214 (e.g., by switching valve 220 to and/or maintaining valve 220 in an appropriate position). In some embodiments, the first permeate 114 can be stored in second vessel 204 until the system is ready to perform a second filtration step.

According to certain embodiments, during the second filtration step, the liquid fed to the retentate side of the filter can be recirculated between a vessel and the retentate side of the filter. Such recirculation can be performed, for example, to ensure that the resulting retentate liquid has a desired amount of one or more minor components (e.g., the target minor component). Referring to FIG. 2, for example, in some embodiments, liquid feed from second vessel 204 can be transported to retentate side 102 of filter 101 via streams 216 and 108 (e.g., by switching valve 218 to and/or maintaining valve 218 in an appropriate position), after which the retentate may be transported back to second vessel 204 via streams 112 and 212 (e.g., by switching valve 222 to and/or maintaining valve 222 in an appropriate position). In some such embodiments, the liquid that is transported back to second vessel 204 can be subsequently transported back to retentate side 102 of filter 101 for further filtration. In some embodiments, liquid can be recirculated between vessel 204 and retentate side 102 of filter 101 until the concentration of the minor component (e.g., the target minor component) within the recirculated liquid reaches a desired level.

In some embodiments, during and/or after the second hydraulic pressure differential establishing step (and, in some embodiments, before a third hydraulic pressure differential establishing step), at least a portion (e.g., at least about 10 wt %, at least about 25 wt %, at least about 50 wt %, at least about 75 wt %, at least about 90 wt %, at least about 95 wt %, at least about 99 wt %, or all) of the second permeate is transported to a vessel (e.g., the first vessel or another vessel fluidically connected to the filtration system). In some such embodiments, the portion of the second permeate can be stored in the vessel until an additional filtration step is performed. For example, referring to FIG. 2, during and/or after the filtration of the first permeate contained in second vessel 204, the second permeate can be transported to first vessel 202 via streams 114 and 208 (e.g., by switching valve 220 to and/or maintaining valve 220 in an appropriate position). In some embodiments, the second permeate can be stored in first vessel 202 until the system is ready to perform a third filtration step.

In some embodiments, during and/or after the second hydraulic pressure differential establishing step (and, in some embodiments, before a third hydraulic pressure differential establishing step), at least a portion (e.g., at least about 10 wt %, at least about 25 wt %, at least about 50 wt %, at least about 75 wt %, at least about 90 wt %, at least about 95 wt %, at least about 99 wt %, or all) of the second permeate is mixed with a portion of the original liquid feed. In some such embodiments, the mixture of the second permeate portion and the original liquid feed portion can be transported to the filter. In some such embodiments, a hydraulic pressure differential may be established across the filtration medium to produce an additional permeate stream (enriched in the major component relative to the mixture) and an additional retentate stream (enriched in a minor component, such as the target minor component, relative to the mixture).

Some embodiments comprise transporting at least a portion (e.g., at least about 10 wt %, at least about 25 wt %, at least about 50 wt %, at least about 75 wt %, at least about 90 wt %, at least about 95 wt %, at least about 99 wt %, or all) of the second permeate to the retentate side of the filter and establishing a hydraulic pressure differential across the filtration medium within the filter containing the portion of the second permeate to produce a third permeate enriched in the major component relative to the second permeate and a third retentate enriched in the minor component relative to the second permeate. For example, referring to FIG. 2, in some embodiments, at least a portion of the permeate produced during the second filtration step can be transported to retentate side 102 of filter 101 via streams 210 and 108 (e.g., by switching valve 218 to and/or maintaining valve 218 in an appropriate position). A hydraulic pressure differential can be established across filtration medium 106 of filter 101 to produce a third permeate enriched in the major component relative to the second permeate and a third retentate enriched in the minor component relative to the second permeate.

The step of establishing a hydraulic pressure differential across the filtration medium while the filter receives the second permeate can be temporally separate from the step of establishing a hydraulic pressure differential across the filtration medium while the filter receives the first permeate. For example, in some embodiments, flow of the first permeate from the second vessel to the filter can be stopped or substantially stopped, after which at least a portion (e.g., at least about 10 wt %, at least about 25 wt %, at least about 50 wt %, at least about 75 wt %, at least about 90 wt %, at least about 95 wt %, at least about 99 wt %, or all) of the second permeate can be transported (e.g., from first vessel 202) to retentate side 102 of filter 101. A hydraulic pressure differential may then be applied across filtration medium 106 of filter 101 to produce a third retentate and a third permeate from the portion of the second permeate.

According to certain embodiments, during the third filtration step, the liquid fed to the retentate side of the filter can be recirculated between the first vessel (or another vessel fluidically connected to the filtration system) and the retentate side of the filter. Referring to FIG. 2, for example, in some embodiments, liquid from first vessel 202 can be transported to retentate side 102 of filter 101 via streams 210 and 108 (e.g., by switching valve 218 to and/or maintaining valve 218 in an appropriate position), after which the retentate may be transported back to first vessel 202 via streams 112 and 206 (e.g., by switching valve 222 to and/or maintaining valve 222 in an appropriate position). In some such embodiments, the liquid that is transported back to first vessel 202 can be subsequently transported back to retentate side 102 of filter 101 for further filtration. In some embodiments, liquid can be recirculated between vessel 202 and retentate side 102 of filter 101 until the concentration of the minor component (e.g., the target minor component) within the recirculated liquid reaches a desired level.

Operation of system 200 can be continued in the manner outlined above until a desired amount of the minor component present in the initial liquid feed is recovered from the system. Accordingly, some embodiments comprise performing fourth, fifth, sixth, or more temporally separated filtration steps.

According to certain embodiments, when liquid from the permeate side of the filter is added to a vessel within the filtration system, mixing of the permeate liquid may be substantially or completely avoided. By substantially avoiding (or completely avoiding) the level of mixing of the permeate liquid within the vessel, the liquid within the vessel can have a stratified concentration of the minor component (e.g., the target minor component). As one particular example, in embodiments in which the initial liquid mixture comprises water and ethanol, the ethanol concentration of the permeate produced will typically rise as filtration proceeds, since the rate of diffusion of ethanol through the filtration medium increases when the feed is at higher ethanol concentration. The later-formed permeate (higher in ethanol content) will generally float above the prior-formed permeate (lower in ethanol content) within the vessel into which it is being channeled, due to buoyancy differences.

While an example has been given in which the concentration of the target minor component increases as a function of the depth of the liquid in the vessel, in other cases, the target minor component may have a concentration that decreases as a function of depth of the liquid in the vessel.

Establishing a concentration gradient of the target minor component within a vessel of the filtration system can be beneficial for a number of reasons. For example, the permeate within the portion of the vessel having a relatively low concentration of the target minor component could be allowed, according to certain embodiments, to bypass subsequent filtration steps, as it may already be sufficiently low in concentration in the target minor component. In addition, in some cases, during subsequent filtration steps, an improved level of target minor component rejection and energy consumption could be achieved compared to the filtration of the non-stratified (i.e., well mixed) liquid.

Without wishing to be bound by any particular theory, it is believed that mixing that occurs within the vessel generally results in an increase in entropy. This increase in entropy can increase the minimum work required for the removal of the major component from the resultant mixture, compared to the minimum work required for the removal of the major component from the fluid in its unmixed state. In a pressure driven process of major component removal, the increase in the minimum work requirement that results from mixing generally manifests itself as an increase in the average osmotic pressure observed on the retentate side of filter(s)—averaged over permeate production—for the removal of a given mass of the major component. For a process of major component removal that occurs within a fixed period of time and that employs a fixed filter area, an increase in the average osmotic pressure generally results in an increase in the required hydraulic pressure, and thus, an increase in energy requirements for pressurization. In certain pressure-driven reverse osmosis processes employing thin film composite membranes as filters, the minor component passage percentage (one minus the minor component rejection percentage) is roughly proportional to the concentration difference of the minor component across the osmotic membrane (i.e., the difference between the retentate side and the permeate side). Also, generally, the osmotic pressure of a mixture in such processes can increase roughly linearly with minor component concentration. As noted above, mixing generally results in an increase in entropy that manifests itself as an increase in the average osmotic pressure seen on the retentate side of the membranes. The roughly linear relationship between concentration and osmotic pressure means that, in such cases, an increase in average osmotic pressure can be interpreted as an increase in the average concentration difference—averaged over permeate production—of the minor component across the membrane during a process of major component removal that occurs within a fixed period of time and employs a fixed filter area. Thus, increased levels of mixing can increase the minor component passage percentage and reduce the minor component rejection percentage. For at least these reasons, mixing of the liquid(s) (e.g., permeate(s) and/or retentate(s)) within the vessel(s) can, in certain but not necessarily all cases, be undesirable.

Accordingly, in certain embodiments, after the first permeate has been transported to the second vessel, the weight percentage of the minor component increases monotonically as a function of height within the second vessel from a first region containing the minor component at a first weight percentage to a second region containing the minor component at a second weight percentage that is higher than the first weight percentage. In certain embodiments, the weight percentage of the minor component within the first region (of lower weight percentage) is at least about 5% less, at least about 10% less, at least about 25% less, or at least about 50% less than the weight percentage of the minor component within the second region (of higher weight percentage). The percentage difference between the weight percentage within the first region (w_{R1}) and the weight percentage within the second region (w_{R2}) is calculated as:

$$\% Difference = \frac{{w}_{R 2} - {w}_{R 1}}{{w}_{R 2}} \times 100 \%$$

In some such embodiments, the region containing the minor component at the first weight percentage is at the top of the permeate liquid in the vessel or near the top of the permeate liquid in the vessel (e.g., within the top 5% of the permeate liquid level, by height). In some such embodiments, the region containing the minor component at the second weight percentage is at the bottom of the permeate liquid in the vessel or near the bottom of the permeate liquid in the vessel (e.g., within the bottom 5% of the permeate liquid level, by height).

In some embodiments, the region containing the minor component at the first weight percentage is at the bottom of the permeate liquid in the vessel or near the bottom of the permeate liquid in the vessel (e.g., within the bottom 5% of the permeate liquid level, by height). In some such embodiments, the region containing the minor component at the second weight percentage is at the top of the permeate liquid in the vessel or near the top of the permeate liquid in the vessel (e.g., within the top 5% of the permeate liquid level, by height).

According to certain embodiments, the region containing the minor component at the first weight percentage and the region containing the minor component at the second weight percentage are spatially separated by a distance of at least about 1 centimeter, at least about 2 centimeters, at least about 5 centimeters, at least about 10 centimeters, at least about 50 centimeters, at least about 1 meter, or more (and/or, in certain embodiments, up to about 10 meters, up to about 100 meters, or more). In some embodiments, the region containing the minor component at the first weight percentage and the region containing the minor component at the second weight percentage are spatially separated by a distance that is at least about 25%, at least about 50%, at least about 75%, at least about 85%, at least about 90%, or at least about 95% of the height of the vessel within which the first and second portion are contained.

In some embodiments, stratification of the minor component within the vessel can be achieved by positioning an inlet of the vessel through which permeate from the filter is transported into the vessel at the top of the vessel or near the top of the vessel (e.g., within the top 5% of the vessel's height). In some embodiments, the filtration system is operated such that the inlet of the vessel through which permeate is transported is maintained above the level of the liquid contained within the vessel during operation. For example, referring to FIG. 2, in some embodiments, system 200 is operated such that inlet 250 (fluidically connected to stream 208) remains above the liquid level within vessel 202 during operation of filtration system 200. In certain embodiments, system 200 of FIG. 2 is operated such that inlet 252 (fluidically connected to stream 214) remains above the liquid level within vessel 204 during operation of filtration system 200.

According to certain embodiments, the stratification of the minor component concentration (e.g., the target minor component concentration) within the vessel can lead to a change in the concentration of the minor component (e.g., the target minor component) within the liquid exiting the vessel as a function of time. For example, in embodiments in which the concentration of ethanol increases as a function of the depth of the liquid in the vessel, the concentration of ethanol in the liquid exiting the vessel can increase as a function of time, as the liquid more concentrated in ethanol exits the vessel first, followed by liquid that is less concentrated in ethanol. Such behavior can be observed, according to certain embodiments, by locating the outlet of the vessel at the bottom of the vessel or near the bottom of the vessel (e.g., within the bottom 5% of the height of the vessel).

Accordingly, in some embodiments, over at least a portion of the step of transporting the first permeate from the vessel to the filter (e.g., from vessel 204 to retentate side 102 of filter 101), the weight percentage of the minor component (e.g., the target minor component) contained within the permeate exiting the vessel changes (e.g., increases or decreases) as a function of time. In certain embodiments, over at least a portion of the step of transporting the second permeate from a vessel to the filter (e.g., from vessel 202 to retentate side 102 of filter 101), the weight percentage of the minor component (e.g., the target minor component) contained within the second permeate exiting the vessel changes (e.g., increases or decreases) as a function of time. In some embodiments, the weight percentage of the minor component (e.g., the target minor component) contained within a permeate exiting a vessel changes by at least about 5%, at least about 10%, at least about 25%, at least about 50%, at least about 100%, at least about 200%, or at least about 300% relative to the weight percentage of the minor component in the permeate that initially exits the vessel. The percentage change in the weight percentage of the minor component within a permeate at time t (wₜ) relative to the weight percentage of the minor component in the permeate that initially exits the vessel (wᵢ) is calculated as:

$$\% Change = \frac{\vert {w}_{i} - {w}_{t} \vert}{{w}_{i}} \times 100 \%$$

According to certain embodiments, when liquid from the retentate side of the filter is added to a vessel within the filtration system, mixing of the retentate liquid may be substantially or completely avoided. By substantially avoiding (or completely avoiding) the level of mixing of the retentate liquid within the vessel, the retentate liquid within the vessel can have a stratified concentration of the minor component (e.g., the target minor component). As one particular example, in certain embodiments in which the initial liquid mixture comprises water and ethanol, the ethanol concentration of the retentate produced will typically rise as filtration proceeds when certain filtration media are used, since the passage of ethanol through the membrane is, in some such cases, largely—but not completely—impeded. The later-formed retentate (higher in ethanol content) will generally float above the prior-formed retentate (lower in ethanol content) within the vessel into which it is being channeled, due to buoyancy differences.

Establishing such concentration gradients of the target minor component can be advantageous, according to certain embodiments, for at least the reasons noted above with respect to the stratification of the permeate. For example, the retentate within the portion of the vessel having a relatively high concentration of the target minor component could be allowed, according to certain embodiments, to bypass subsequent filtration steps, as it may already be sufficiently high in concentration in the target minor component. In addition, in some cases, during subsequent filtration steps, an improved level of target minor component rejection and energy consumption could be achieved compared to the filtration of the non-stratified (i.e., well mixed) liquid.

In certain embodiments, after the first retentate has been transported to a vessel (e.g., the first vessel such as first vessel 202 in FIG. 2 or a third vessel (not shown in FIG. 2)), the weight percentage of the minor component increases monotonically as a function of height within the vessel from a first region of the retentate containing the minor component at a first weight percentage to a second region of the retentate containing the minor component at a second weight percentage that is higher than the first weight percentage. In some embodiments, the first retentate can be transported to a vessel that is the same as the liquid feed vessel. For example, in some embodiments, the liquid feed and the retentate are transported between the liquid feed vessel and the retentate side of the filter, for example, in a recirculating pathway. In some embodiments, the first retentate within the liquid feed vessel can have a stratified concentration of one or more minor components within the liquid feed vessel. In certain embodiments, the first retentate can be transported to a vessel that is different from the liquid feed vessel, and the first retentate within the vessel that is different from the liquid feed vessel can have a stratified concentration of one or more minor components.

In certain embodiments, the weight percentage of the minor component within the first region of the retentate (of lower weight percentage) is at least about 5% less, at least about 10% less, at least about 25% less, or at least about 50% less than the weight percentage of the minor component within the second region of the retentate (of higher weight percentage).

In some such embodiments, the region containing the minor component at the first weight percentage is at the top of the retentate liquid in the vessel or near the top of the retentate liquid in the vessel (e.g., within the top 5% of the retentate liquid level, by height). In some such embodiments, the region containing the minor component at the second weight percentage is at the bottom of the retentate liquid in the vessel or near the bottom of the retentate liquid in the vessel (e.g., within the bottom 5% of the retentate liquid level, by height).

In some embodiments, the region containing the minor component at the first weight percentage is at the bottom of the retentate liquid in the vessel or near the bottom of the retentate liquid in the vessel (e.g., within the bottom 5% of the retentate liquid level, by height). In some such embodiments, the region containing the minor component at the second weight percentage is at the top of the retentate liquid in the vessel or near the top of the retentate liquid in the vessel (e.g., within the top 5% of the retentate liquid level, by height).

According to certain embodiments, the region of the retentate containing the minor component at the first weight percentage and the region of the retentate containing the minor component at the second weight percentage are spatially separated by a distance of at least about 1 centimeter, at least about 2 centimeters, at least about 5 centimeters, at least about 10 centimeters, at least about 50 centimeters, at least about 1 meter, or more (and/or, in certain embodiments, up to about 10 meters, up to about 100 meters, or more). In some embodiments, the region of the retentate containing the minor component at the first weight percentage and the region of the retentate containing the minor component at the second weight percentage are spatially separated by a distance that is at least about 25%, at least about 50%, at least about 75%, at least about 85%, at least about 90%, or at least about 95% of the height of the vessel within which the first and second portion are contained.

In some embodiments, stratification of the minor component within the vessel can be achieved by positioning an inlet of the vessel through which retentate from the filter is transported into the vessel at the top of the vessel or near the top of the vessel (e.g., within the top 5% of the vessel's height). In some embodiments, the filtration system is operated such that the inlet of the vessel through which retentate is transported is maintained above the level of the liquid contained within the vessel during operation. For example, as noted above with respect to FIG. 2, in some embodiments, system 200 is operated such that inlet 250 (fluidically connected to stream 208) remains above the liquid level within vessel 202 during operation of filtration system 200. In certain embodiments, system 200 of FIG. 2 is operated such that inlet 252 (fluidically connected to stream 214) remains above the liquid level within vessel 204 during operation of filtration system 200.

As noted above, the stratification of the minor component concentration (e.g., the target minor component concentration) within the vessel can lead, according to certain embodiments, to a change in the concentration of the minor component (e.g., the target minor component) within the liquid exiting the vessel as a function of time. For example, in embodiments in which the concentration of ethanol increases as a function of the depth of the liquid in the vessel (e.g., from a first, relatively low concentration in a region that is relatively low within the liquid in the vessel (e.g., at or near the bottom of the liquid level in the vessel) to a second, relatively high concentration in a region that is relatively high within the liquid in the vessel (e.g., at or near the top of the liquid level in the vessel)), the concentration of ethanol in the liquid exiting the vessel can increase as a function of time, as the liquid more concentrated in ethanol exits the vessel first, followed by liquid that is less concentrated in ethanol. Such behavior can be observed, according to certain embodiments, by locating the outlet of the vessel at the bottom of the vessel or near the bottom of the vessel (e.g., within the bottom 5% of the height of the vessel).

Accordingly, in some embodiments, over at least a portion of the step of transporting the first retentate from the vessel to the filter (e.g., from vessel 202 and/or from a third vessel to retentate side 102 of filter 101), the weight percentage of the minor component (e.g., the target minor component) contained within the retentate exiting the vessel changes (e.g., increases or decreases) as a function of time. In certain embodiments, over at least a portion of the step of transporting the second retentate from a vessel to the filter (e.g., from vessel 204 to retentate side 102 of filter 101), the weight percentage of the minor component (e.g., the target minor component) contained within the second retentate exiting the vessel changes (e.g., increases or decreases) as a function of time. In some embodiments, the weight percentage of the minor component (e.g., the target minor component) contained within a retentate exiting a vessel changes by at least about 5%, at least about 10%, at least about 25%, at least about 50%, at least about 100%, at least about 200%, or at least about 300% relative to the weight percentage of the minor component in the retentate that initially exits the vessel.

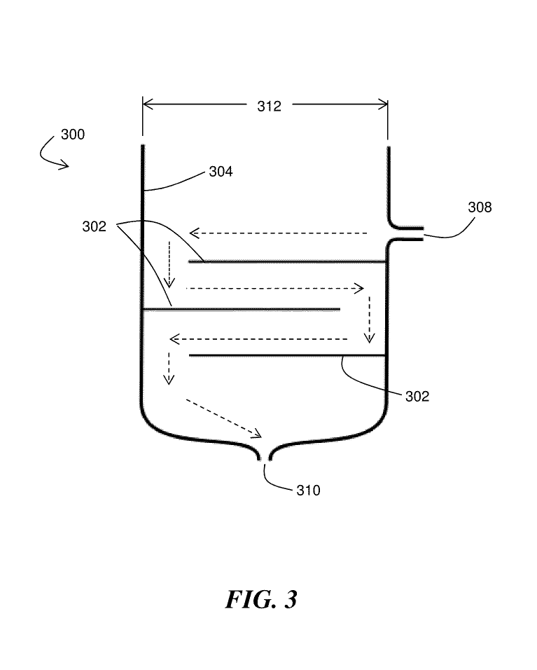

In some embodiments, a vessel may include protrusions (e.g., horizontal protrusions) extending from the inner surface of the vessel (e.g., into the bulk of the vessel). The protrusions may be, according to certain embodiments, configured to maintain the stratification of the liquid permeate within the vessel. For example, in some embodiments, baffles, plates, or other structures can be installed in at least one vessel (and/or all vessels), for example, to inhibit the mixing of permeate liquid within the vessel. The protrusions may extend, according to certain embodiments, from the inner surface of the vessel into the bulk of the vessel, for example, in a direction that is within 60°, within 45°, within 30°, within 15°, within 5°, within 2°, or within 1° of horizontal. In some embodiments, the protrusions may extend from the inner surface of the vessel horizontally. For example, FIG. 3 is a cross-sectional schematic illustration of exemplary vessel 300, in which protrusions 302 extend horizontally from inner surface 304 of vessel 300. Protrusions 302 can be arranged to form a fluidic pathway (defined by dashed arrows in FIG. 3) between inlet 308 of vessel 300 and outlet 310 of vessel 300. Vessel 300 illustrated in FIG. 3 could be used, for example, as the first vessel (e.g., vessel 202 in FIG. 2), as the second vessel (e.g., vessel 204 in FIG. 2), and/or as a third, fourth, or additional vessel. The protrusions may extend, in some embodiments, a distance that is at least about 0.25 times, at least about 0.5 times, at least about 0.6 times, at least about 0.7 times, or at least about 0.8 times the maximum horizontal cross-sectional dimension of the vessel. For example, in FIG. 3, protrusions 302 extend a distance that is about 0.8 times the maximum horizontal cross-sectional dimension 312 of vessel 300. The protrusions may be made of a material that is the same as or different from the material from which the wall of the vessel from which the protrusions extend is made.

In certain embodiments, the concentrations of the minor components (e.g., the target minor components) in the first retentate and the second retentate are relatively close. In some such embodiments, the first retentate and the second retentate can be mixed to form a final product having a desirable concentration of the target minor component while minimizing the amount of energy wasted during the filtration process. In some embodiments, the lower of the weight percentage of the minor component in the first retentate and the weight percentage of the minor component in the second retentate is at least about 0.5 times, at least about 0.75 times, at least about 0.9 times, at least about 0.95 times, at least about 0.98 times, or at least about 0.99 times the higher of the weight percentage of the minor component in the first retentate and the weight percentage of the minor component in the second retentate. Those of ordinary skill in the art would understand that, for the purposes of this calculation, when the concentration of a minor component within a retentate stream exiting the retentate side of the filter varies with time, the weight percentage of that minor component within the retentate is calculated by dividing the total mass of the minor component that exits the retentate side of the filter during the production of the retentate by the total mass of the retentate that exits the filter during the production of the retentate.

As an exemplary illustration of the above-described comparison, the first retentate could contain the target minor component in an amount of 5.0 wt %, and the second retentate could contain the target minor component in an amount of 2.5 wt %. In such a case, the higher of the weight percentage of the target minor component in the first retentate and the weight percentage of the target minor component in the second retentate would be 5.0 wt % (corresponding to the weight percentage of the target minor component in the first retentate). In addition, in such a case, the lower of the weight percentage of the target minor component in the first retentate and the weight percentage of the target minor component in the second retentate would be 2.5 wt % (corresponding to the weight percentage of the target minor component in the second retentate). In this case, the lower of the weight percentage of the target minor component in the third retentate and the weight percentage of the target minor component in the liquid feed (2.5 wt %) is 0.5 times the higher of the weight percentage of the target minor component in the third retentate and the weight percentage of the target minor component in the liquid feed (5.0 wt %) (i.e., 2.5 wt % is 0.5 times 5.0 wt %).

In certain embodiments, the concentrations of the minor components (e.g., the target minor component) in the liquid feed and the second retentate are relatively close. In some such embodiments, the second retentate can be mixed with a fresh batch of liquid feed prior to performing additional filtration steps. By ensuring that the second retentate and the liquid feed have similar concentrations of the target minor component, the amount of energy wasted during the subsequent filtration step can be reduced. In some embodiments, the lower of the weight percentage of the minor component in the liquid feed and the weight percentage of the minor component in the second retentate is at least about 0.5 times, at least about 0.75 times, at least about 0.9 times, at least about 0.95 times, at least about 0.98 times, or at least about 0.99 times the higher of the weight percentage of the minor component in the liquid feed and the weight percentage of the minor component in the second retentate. Those of ordinary skill in the art would understand that, for the purposes of this calculation, when the concentration of a minor component within the liquid feed entering the filter varies with time, the weight percentage of that minor component within the liquid feed stream is calculated by dividing the total mass of the minor component that enters the filter during the production of the second retentate by the total mass of the liquid feed stream that enters the filter during the production of the second retentate. Similarly, those of ordinary skill in the art would understand that, for the purposes of this calculation, when the concentration of a minor component within the second retentate exiting the retentate side of the filter varies with time, the weight percentage of that minor component within the second retentate is calculated by dividing the total mass of the minor component that exits the retentate side of the filter during the production of the second retentate by the total mass of the second retentate that exits the filter during the production of the second retentate.

Certain of the systems and methods described herein can be used to concentrate one or more minor components within a variety of types of liquid feeds (e.g., liquid mixtures fed to the system, for example, via stream 108 in FIGS. 1-2).

The liquid feed can comprise a number of suitable major components. In certain embodiments, the major component is a liquid. For example, the major component can be a consumable liquid. According to certain embodiments, the major component is non-ionic (i.e., the major component does not have a net ionic charge). The major component can have a molecular weight of less than about 150 g/mol, less than about 100 g/mol, less than about 50 g/mol, or less than 25 g/mol, according to some embodiments. For example, in some embodiments, the major component is water. In some embodiments, the major component can be a solvent.

The liquid feed can contain a number of suitable minor components. As noted above, certain liquid feed mixtures can include exactly one minor component while other mixtures may contain more than one minor component. In certain embodiments, at least one (or all) of the minor components (e.g., the target minor component) is a liquid. For example, at least one (or all) of the minor components (e.g., the target minor component) can be a consumable liquid. According to certain embodiments, at least one (or all) of the minor components (e.g., the target minor component) is non-ionic (i.e., the minor component does not have a net ionic charge). According to some embodiments, at least one (or all) of the minor components (e.g., the target minor component) can have a molecular weight of less than about 150 g/mol, less than about 100 g/mol, or less than about 50 g/mol (and/or, in some embodiments, at least about 25 g/mol, at least about 35 g/mol, or at least about 40 g/mol). In some embodiments, at least one of the minor components is an alcohol, such as ethanol.

In some embodiments, the target minor component is a co-solvent with the major component. For example, in some embodiments, ethanol can act as a co-solvent with water, for example, dissolving one or more salts within the liquid feed. In other embodiments, the target minor component does not act as a solvent.

According to certain embodiments, the liquid feed containing the major component and the minor component(s) can be a consumable mixture. In some embodiments, the liquid feed is an aqueous mixture. In some embodiments, the liquid feed comprises water as the major component and ethanol as a minor component (e.g., the target minor component). In some embodiments in which water and ethanol are components of the liquid feed, the liquid feed can further comprise one or more sugars. According to certain embodiments, the liquid feed is an alcoholic beverage, such as beer, wine, and the like. In some, but not necessarily all, cases the systems and methods described herein can be particularly advantageous in producing concentrates of beer.

In certain embodiments, the concentration of at least one minor component (e.g., the target minor component) in the liquid feed is relatively high. For example, in certain embodiments, the concentration of a minor component (e.g., the target minor component) in the liquid feed (e.g., in stream 108 of FIGS. 1-2) is at least about 0.001% by weight, at least about 0.01% by weight, at least about 0.1% by weight, or at least about 1% by weight (and/or, in certain embodiments, up to about 5% by weight, up to about 10% by weight, up to about 15% by weight, up to about 20% by weight, or more). Such relatively high concentrations of a minor component(s) can be observed, for example, in systems for the concentration of alcoholic beverages (e.g., beer, wine, and the like). The use of high minor component concentrations is not required, however, and in some embodiments, the concentration of a minor component (e.g., the target minor component) in the liquid feed can be as low as 0.0001% by weight, as low as 0.00001% by weight, or lower.

According to certain embodiments, the minor component(s) (e.g., the target minor component) is a component that is not highly rejected by traditional filtration media, such as reverse osmosis membranes, nanofiltration membranes, and/or ultrafiltration membranes. Thus, in some embodiments, the rejection percentage (the calculation of which for particular minor components is described below) of one or more filtration media with respect to a minor component (e.g., the target minor component) can be relatively low. According to certain embodiments, the rejection percentage of the minor component (e.g., the target minor component) with respect to a filtration medium within a filter of the filtration system is between about 10% and about 95%, between about 95% and about 99%, between about 35% and about 90%, or between about 60% and about 90%. According to certain embodiments, the rejection percentage of the minor component (e.g., the target minor component) with respect to a filtration medium within a filter of the filtration system is between about 10% and about 99%. For example, in some embodiments, the rejection percentage of the minor component (e.g., the target minor component) with respect to filtration medium 106 of filter 101 of filtration system 200 is between about 10% and about 99%, between about 10% and about 95%, between about 35% and about 90%, or between about 60% and about 90%.

The rejection percentage of a filtration medium with respect to a particular minor component is generally calculated by dividing the weight percentage of the minor component within the permeate stream by the weight percentage of the minor component within the liquid feed stream, and multiplying by 100%, when the filter is operated at steady state. When determining the rejection percentage of a filtration medium with respect to a minor component, the filtration medium should be arranged as a single spiral wound membrane element that is 8 inches in diameter and 40 inches in length. The filtration medium should contain 30 mil thick feed channel spacers to produce an active membrane area that is 400 square feet. The permeate flow rate should be equal to 10% of the feed flow rate. In addition, the feed stream should include only the minor component whose rejection percentage is being determined and the major component, with the concentration by of the minor component at a level such that the osmotic pressure of the feed stream is 26 bar. In addition, the feed stream should be set at a temperature of 25 degrees Celsius, have a pH of 7, and be fed to the filter at a pressure of 800 psi gauge.

In some cases, the osmotic pressure differential across the filtration medium (Δπ) can vary substantially from the osmotic pressure of the feed, for example, if minor components contained within the feed stream are not well rejected by the filtration medium.

In cases in which the osmotic pressure differential varies from the osmotic pressure of the feed, it may be desirable to achieve a substantially continuous rate of major component transfer across the filtration medium. However, if the hydraulic pressure on the retentate side is not adjusted to account for variations in the osmotic pressure differential, the rate of transfer of the major component across the filtration medium will be variable. Accordingly, in some embodiments, the net driving pressure differential across the filtration medium (e.g., filtration medium 106 of FIGS. 1 and 2) is maintained at a substantially constant value as a function of time during operation of the filtration system.

The net driving pressure differential (ΔP_{Net}) corresponds to the difference between the established hydraulic pressure differential across the filtration medium (ΔP_{E}) and the osmotic pressure differential across the filtration medium (Δπ), and can be calculated as follows:

ΔP_{Net}=ΔP_{E}−Δπ=(P_{R}−P_{P})−(π_{R}−π_{P})

In certain cases, the osmotic pressure may not be uniform on the retentate side (π_{R}) or the permeate side (π_{P}) of the filter. Accordingly, for the purposes of calculating the net pressure differential, the osmotic pressure on the retentate side of the filter is calculated as the spatial average osmotic pressure at the surface of the retentate side of the filtration medium, and the osmotic pressure on the permeate side of the filter is determined as the spatial average osmotic pressure at the surface of the permeate side of the filtration medium. Such osmotic pressures can be calculated by positioning component concentration sensors at a statistically representative number of points on the retentate and permeate sides of the filtration medium.

In addition, in some cases, the gauge pressure may not be uniform on the retentate side (P_{R}) or the permeate side (P_{P}) of the filter. Accordingly, for the purposes of calculating the net pressure differential, the gauge pressure on the retentate side of the filter is calculated as the spatial average gauge pressure at the surface of the retentate side of the filtration medium, and the gauge pressure on the permeate side of the filter is determined as the spatial average gauge pressure at the surface of the permeate side of the filtration medium. Such gauge pressures can be calculated by positioning pressure sensors at a statistically representative number of points on the retentate and permeate sides of the filtration medium.

In some embodiments, during a majority of the time over which the hydraulic pressure differential is applied across the filter (e.g., over at least about 50%, at least about 70%, at least about 90%, at least about 95%, at least about 99%, or all of the time over which the hydraulic pressure differential is applied) the net driving pressure differential is maintained at a substantially constant value (i.e., within about 50%, within about 25%, within about 10%, within about 5%, within about 2%, or within about 1% of a time-averaged value during the period of time over which the hydraulic pressure differential is applied across the filter). Maintaining the net driving pressure differential at a substantially constant value may be achieved, for example, by adjusting the hydraulic pressure differential established across the filtration medium, for example, in response to a change in the concentration of one or more minor components in the permeate.

In certain cases in which the average osmotic pressure differential across the filtration medium varies in time during a hydraulic pressure differential application step, it may be desirable to achieve a substantially continuous rate of major component transfer across the filtration medium during that step. However, if the hydraulic pressure on the retentate side of the filter is not adjusted to account for variations in the osmotic pressure differential, the rate of transfer of the major component across the filtration medium will vary in time. Accordingly, in some embodiments, the average net driving pressure differential across the filtration medium of the filter (e.g., filtration medium 106 of filter 101 in FIG. 1) or the mass flow rate of the permeate is maintained at a substantially constant value during a majority of the time over which the hydraulic pressure differential is applied to the filter. For example, in some embodiments, during a majority of the time during which the hydraulic pressure differential is applied across the filter (e.g., over at least about 50%, at least about 70%, at least about 90%, at least about 95%, at least about 99%, or all of the time over which the hydraulic pressure differential is applied across the filter) the average net driving pressure differential is maintained at a substantially constant value (i.e., within 50%, within 25%, or within 5% of the time averaged average net driving pressure differential during the period over which the hydraulic pressure differential is applied). In some embodiments, during a majority of the time during which the hydraulic pressure differential is applied across the filter (e.g., over at least about 50%, at least about 70%, at least about 90%, at least about 95%, at least about 99%, or all of the time over which the hydraulic pressure differential is applied across the filter) the permeate flow rate from the filter is maintained at a substantially constant value (i.e., within 50%, within 25%, or within 5% of the time averaged permeate flow rate during that period of operation). Maintaining the permeate volumetric flow rate or the average net driving pressure differential at substantially similar values in time may be achieved, for example, by adjusting the hydraulic pressure of the stream entering the retentate side of the filter in response to the measured permeate volumetric flow rate, since permeate volumetric flow rate (\dot{V}ₚ) and average net driving pressure differential are linked by the surface area of the filtration medium (A) and its permeability (Aₘ) as follows:

\dot{V}ₚ=AAₘΔP_{Net}.

The permeability Aₘ can be approximated, at a given level of hydraulic pressure difference (ΔP_{E}), by measuring the flow rate of the major component through the filtration medium, per unit area of the filtration medium and per unit of applied hydraulic pressure difference, when a solution consisting solely of the major component is present on the retentate and permeate sides of the filtration medium.

The osmotic pressure (π) of a particular liquid mixture containing n minor components is generally calculated as:

$$Π = {\sum }_{j = 1}^{n} {i}_{j} {C}_{j} R T$$

wherein iⱼ is the van't Hoff factor of the j^{th} minor component, Cⱼ is the molar concentration of the t minor component, R is the ideal gas constant, and T is the absolute temperature of the mixture. For the purposes of determining the osmotic pressure of a liquid stream (e.g., a feed stream, a permeate stream, a retentate stream, etc.) the osmotic pressure is calculated by measuring average concentrations of minor components within the stream, and calculating II using the above equation. For mixtures containing a single minor component, the osmotic pressure (π) is calculated as:

π=iCRT

wherein i is the van't Hoff factor of the minor component, C is the molar concentration of the minor component, R is the ideal gas constant, and T is the absolute temperature of the mixture.

The net driving pressure differential could be controlled using methods that would be apparent to those of ordinary skill in the art, given the insights provided by the instant disclosure. For example, in some embodiments, the net driving pressure differential could be controlled by measuring the permeate flow rate and adjusting the applied pressure to keep the permeate flow rate constant in time.

In certain embodiments, the net driving pressure differential could be controlled using an open loop pressure control scheme. For example, if one assumes reasonable rejection of solutes that contribute most to the osmotic pressure of the retentate side solution, the bulk osmotic pressure of the retentate (π_{R}) rises with time (t) as follows:

$${Π}_{R} ( t = τ ) \approx \frac{{Π}_{R} ( t = 0 )}{1 - \frac{\dot{V} \times τ}{{V}_{0}}}$$

where \dot{V} is the volume flow rate of permeate and V₀ is the initial volume on the retentate side. The flow of permeate, \dot{V}, is given by:

\dot{V}≈A×Aₘ×(ΔP_{E}(t)−(π_{R}(t)×CPF))

where A is the membrane area, Aₘ is the membrane permeability, ΔP_{E} is the established hydraulic pressure differential between the retentate and permeate side, and CPF is the concentration polarization factor. The concentration polarization factor (CPF) can be determined empirically for a system by measuring the flow rate of permeate obtained using a known feed stream composition, a known established hydraulic pressure differential, retentate gauge pressure, and membrane area. The permeate osmotic pressure can be ignored to obtain a first order approximation. Solving the above equation yields an expression for the hydraulic pressure required as a function of time in terms of known quantities:

$$Δ {P}_{E} ( t ) \approx \frac{\dot{V}}{A \times {A}_{m}} + \frac{{Π}_{R} ( t ) \times C P F}{1 - \frac{\dot{V} \times t}{{V}_{0}}}$$

A variety of filters can be used in association with the embodiments described herein. In certain embodiments, the filter comprises a filtration medium. The filtration medium comprises, according to certain embodiments, any medium, material, or object having sufficient hydraulic permeability to allow at least a portion of the major component of the liquid fed to the filter to pass through the medium, while, at the same time, retaining and/or preventing passage of at least a portion of the minor component(s) of the liquid fed to the filter.

Exemplary filters that may be utilized in various of the embodiments described herein include, but are not limited to, gel permeation filters and membrane-based filters. For example, the filter can be a spiral filter, a flat sheet filter, a hollow fiber filter, a tube membrane filter, or any other type of filter.

The filters described herein can comprise any suitable filtration medium. In some embodiments, the filtration medium comprises a filtration membrane (e.g., a semipermeable membrane). The filtration medium can be fabricated from a variety of materials. For example, the filtration medium can be fabricated from inorganic materials (e.g., ceramics), organic materials (e.g., polymers), and/or composites of inorganic and organic materials (e.g., ceramic and organic polymer composites). Suitable polymeric materials from which the filtration medium may be fabricated include, but are not limited to, poly(tetrafluoroethylene), polysulfones, polyamides, polycarbonates, polyesters, polyethylene oxides, polypropylene oxides, polyvinylidene fluorides, poly(acrylates), and co-polymers and/or combinations of these. In certain embodiments, the filtration medium comprises a polyamide-based salt rejecting layer.

In certain embodiments, the filtration medium is in the form of a thin film membrane, for example, having a thickness of less than about 1 millimeter, less than about 500 micrometers, or less than about 250 micrometers. In some embodiments, the filtration medium is a thin-film composite membrane.

According to certain embodiments, the filtration medium can be selected to have a porosity and molecular weight cutoff that allows passage of the major component of the liquid feed through the filtration medium while retaining a sufficiently large portion of the minor component(s) that the minor component(s) (e.g., the target minor component) is concentrated on the retentate side of the filtration medium. In embodiments where the filtration medium is used to de-water a liquid feed, the filtration membrane can be selected so that it is able to freely pass water, while, at the same time, retaining, on the retentate side, a sufficient amount of the minor component(s) (e.g., the target minor component) to result in concentration of the minor component on the retentate side of the filtration medium.

According to certain embodiments, the filtration medium is a reverse osmosis membrane. The reverse osmosis membrane can have an average pore size of less than about 0.001 micrometers, in some embodiments. In certain embodiments, the reverse osmosis membrane can have a molecular weight cutoff of less than about 200 g/mol. In some embodiments, the filtration medium is a nanofiltration membrane. The nanofiltration membrane can have an average pore size of between about 0.001 micrometers and about 0.01 micrometers, in some embodiments. In certain embodiments, the nanofiltration membrane can have a molecular weight cutoff of between about 200 g/mol and about 20,000 g/mol. In certain embodiments, the filtration medium is an ultrafiltration membrane. The ultrafiltration membrane can have, according to certain embodiments, an average pore size of between about 0.01 micrometers and about 0.1 micrometers. In some embodiments, the ultrafiltration membrane has a molecular weight cutoff of between about 20,000 g/mol and about 100,000 g/mol. In some embodiments, the filtration medium is a microfiltration membrane. The microfiltration membrane can have an average pore size of between about 0.1 micrometers and about 10 micrometers, according to certain embodiments. In some embodiments, the microfiltration membrane has a molecular weight cutoff of between about 100,000 g/mol and about 5,000,000 g/mol.

According to certain embodiments, at least one (or all) of the filtration media used in the filtration system has a relatively high standard salt rejection. The standard salt rejection is a term generally known to those of ordinary skill in the art, is generally measured as a percentage, and can be determined using the following test. A 400 square foot sample of the filtration medium is assembled into a spiral wound element of 40 inches in length and 8 inches in diameter, having a retentate spacer thickness (i.e., the distance from the retentate wall to the filtration medium) of 30 mil and a permeate spacer thickness (i.e., the distance from the permeate wall to the filtration medium) of 30 mil. A feed stream containing water and dissolved NaCl at a concentration of 32,000 mg/L and a pH of 7 is fed to the retentate side of the filter. The feed is pressurized to 800 psi gauge, with the permeate side of the filter maintained at atmospheric pressure. The filter is operated at a recovery ratio (i.e., the permeate flow rate divided by the feed flow rate, multiplied by 100%) of 10% and a temperature of 25° C. The standard salt rejection is determined, after 30 minutes of operation and at steady state, using the following formula:

$${R}_{S} = \frac{{w}_{NaCl , permeate}}{{w}_{NaCl , feed}} \times 100 \%$$

W_{NaCl,permeate} is the weight percentage of NaCl in the permeate and W_{NaCl,feed} is the weight percentage of NaCl in the feed. According to certain embodiments, at least one (or all) of the filtration media used in the filtration system has a standard salt rejection of at least about 99%, at least about 99.5% or at least about 99.8%.

According to certain embodiments, the filter comprises a vessel within which the filtration medium is housed. In some embodiments, the vessel is configured to withstand a relatively high internal hydraulic pressure without rupturing. The ability of the filter vessel to withstand high hydraulic pressures can be advantages in certain cases in which high hydraulic pressures are employed to achieve a desired degree of separation between the major component and the minor component(s) of the liquid fed to the filter. In some embodiments, the vessel of the filter is configured to withstand an internal hydraulic pressure of at least about 3900 psi gauge without rupturing.

According to certain embodiments, the filtration systems described herein can be configured to operate at relatively high hydraulic pressures. In some embodiments, the pumps, conduits, and/or any other system components can be operated at a hydraulic pressure of at least about 400 psi without failing.

Examples of suitable filters that could be used in association with certain of the embodiments described herein include, but are not limited to, those available from Hydranautics (Oceanside, Calif.) (e.g., under part numbers ESPA2-4040, ESPA2-LD-4040, ESPA2-LD, ESPA2MAX, ESPA4MAX, ESPA3, ESPA4-LD, SanRO HS-4, SanRO HS2-8, ESNA1-LF2-LD, ESNA1-LF2-LD-4040, ESNA1-LF-LD, SWC4BMAX, SWC5-LD-4040, SWC5-LD, SWC5MAX, SWC6-4040, SWC6, SWC6MAX, ESNA1-LF2-LD, ESNA1-LF-LD, ESNA1-LF2-LD-4040, ESNA1-LF-LD-4040, HYDRAcap60-LD, and HYDRAcap60); Dow Filmtec via Dow Chemical Company (Midland, Mich.) (e.g., under part numbers HSRO-390-FF, LC HR-4040, LC LE-4040, SW30HRLE-4040, SW30HRLE-440i, SW30HRLE-400i, SW30HRLE-370/34i, SW30XHR-400i, SW30HRLE-400, SW30HR-380, NF90-400, NF270-400, NF90-4040); Toray Industries, Inc. (e.g., under part numbers TM720-440, TM720C-440, TM720L-440); Koch Membrane Systems, Inc. (Wilmington, Mass.) (e.g., under part numbers 8040-HR-400-34, 8040-HR-400-28); and LG NanoH₂O (El Segundo, Calif.) (e.g., under part numbers Qfx SW 400 ES, Qfx SW 400 SR, Qfx SW 400 R). In some embodiments, the filter comprises a thin film composite membrane. For example, the thin film composite membrane can comprise a non-woven fabric with a thickness of about 150 micrometers used as a mechanical support. A porous polysulfone layer (e.g., roughly 60 micrometers in thickness) can be placed upon the support layer by a phase inversion method. A polyamide layer (e.g., of roughly 200 nm) can be cast upon the polysulfone layer using interfacial polymerization.

Certain of the embodiments described herein involve controlling the concentration(s) of minor component(s) within various portions of the filtration system. Those of ordinary skill in the art, with the insight provided by the instant disclosure, would be capable of selecting suitable operating parameters and/or system components to achieve desired concentration levels using no more than routine experimentation. For example, the surface area of the filtration medium, filtration medium properties, the applied differential hydraulic pressures, flow rates, and other operating parameters can be selected according to the needs of the particular application. As one particular example, the selection of suitable operating parameters and/or equipment characteristics can be based upon the total volume of concentrate to be produced over a given period of time, the amount of incoming liquid feed that is to be concentrated over a given period of time, or other factors as apparent to those of ordinary skill in the filtration arts. In some cases, screening tests may be performed for selecting appropriate types of filter vessels and/or filtration media by performing a trial filtration of a dilute liquid feed with a particular filter until a desired degree of concentration is obtained, followed by collecting the concentrate from the retentate side of the filter, reconstituting the liquid feed with a volume of fresh major component (equal to the volume of major component removed during filtration), and comparing the taste and/or flavor characteristics of the reconstituted liquid feed to that of the initial liquid feed. Operating pressures, filter properties, flow rates, and other operating parameters may be selected on the basis of well-known principles filtration and/or separations, described in many well-known and readily available texts describing filtration/reverse osmosis, combined with routine experimentation and optimization. Appropriate hydraulic pressures and/or flow rates could be established using feedback control mechanisms (e.g., open or closed loop feedback control mechanisms) known to those of ordinary skill in the art.

In certain embodiments, liquid(s) within filter(s) can be kept at relatively cold temperatures. For example, in some embodiments, the liquid(s) within at least one filter of the filtration systems described herein can be maintained at a temperature of about 8° C. or less (e.g., between about 0° C. and about 8° C.). In some embodiments, the liquids within all filters of the filtration system are maintained at a temperature of about 8° C. or less (e.g., between about 0° C. and about 8° C.).

In certain embodiments, one or more filters may include a gaseous headspace, for example, above a liquid contained within the filter. In some such embodiments, the gaseous headspace may be filled with a gas that does not substantially react with any components of the liquid within the filter. In some such embodiments, the gaseous headspace may be filled with a gas that does not substantially react with any minor components of the liquid within the filter. In some such embodiments, the gaseous headspace may be filled with a gas that does not substantially react with the target minor component of the liquid within the filter. All or a portion of the gaseous headspace may be made up of, for example, carbon dioxide, nitrogen, and/or a noble gas. In some embodiments, all or a portion (e.g., at least about 5 wt %, at least about 25 wt %, or at least about 50 wt %) of the gaseous headspace within at least one filter (or all filters) of the filtration system is made of up carbon dioxide. In some embodiments, the gaseous headspace contains oxygen in an amount of less than about 1 part per billion.

Unless indicated to the contrary, all concentrations and relative abundances of the components described herein are determined using weight percentages.

Fluidic connections between vessels and/or the filter can be made using any suitable connector (e.g., piping, tubing, hoses, and the like). In certain embodiments, fluidic connections between vessels and/or the filter can be made using enclosed conduit capable of withstanding hydraulic pressures applied to the fluids within the conduits without substantially leaking.

In some embodiments, where a single filter is described herein, the single filter can be replaced with multiple filters fluidically connected in parallel. For example, referring to FIG. 2, filter 101 may, according to certain embodiments, be replaced with multiple filters fluidically connected in parallel.

U.S. Provisional Patent Application Ser. No. 62/080,696, filed Nov. 17, 2014 and entitled “Flow Control in Multi-Step Filtration, and Associated Systems,” is incorporated herein by reference in its entirety for all purposes.

The following examples are intended to illustrate certain embodiments of the present invention, but do not exemplify the full scope of the invention.

### Example 1

This example describes the use of a filtration medium to separate ethanol from water.

A sample of a thin film composite reverse osmosis membrane measuring 4.9 cm in diameter was installed within a dead-end, stirred cell (HP4750; Sterlitech). The cell was filled with 300 mL of a 3.9+/−0.05% ABV (alcohol by volume) ethanol-in-water solution at 21 degrees Celsius. A magnetic stirrer was turned on and a pressure of 1000 psi was applied using a nitrogen cylinder connected to the cell. Permeate was collected over a period of 30 minutes. This permeate was discarded and additional permeate was collected for another 20 minutes. After this 20 minute period, a 1 mL sample was taken from the permeate that had been collected. The ethanol content of the permeate samples was determined using gas chromatography in conjunction with a mass spectrometer. Ion chromatogram results, benchmarked against a standard curve for ethanol concentration, indicated a permeate ethanol concentration of 1.76+/−0.003%, corresponding to an ethanol rejection of 55%+/−1%.

In a separate test using the same setup as described above, an aqueous feed solution containing 32,000+/−600 mg/L of NaCl as the sole solute was introduced into the cell. The conductivity of the solution was determined, at 25° C., to be 48.5+/−0.5 mS/cm. The magnetic stirrer was turned on and a pressure of 1000 psi was applied using a nitrogen cylinder connected to the cell. Permeate was collected over a period of 30 minutes. This permeate was discarded and additional permeate was collected for another 15 minutes. After this 15 minute period, the permeate conductivity was determined, at 25° C., to be 1.28+/−0.01 mS/cm. This corresponded to a salt rejection of roughly 97.5+/−1% (which may be lower than the membrane's true value due to leakage of the feed stream around the membrane into the permeate).

### Example 2

This example describes the use of a filtration medium to concentrate beer.

Using the same setup as described in Example 1, a 290+/−10 mL sample of a 4.8% ABV Hefeweizen beer was introduced into the stirred cell. Prior to introducing the beer into the cell, the cell was first purged with carbon dioxide. A cooling jacket was applied around the stirred cell to maintain the fluid at 2+/−5° C. The stirrer was turned on and a pressure of 1000 psi was applied. The test was allowed to run until a mass of permeate roughly equaling half of the initial mass of the feed liquid was produced. The first concentrate was then set aside and stored at 5° C. in a container that had been pre-purged with CO₂.

The cell was rinsed with distilled water and the first permeate was introduced into the cell. Prior to introducing the first permeate into the cell, the cell was purged with carbon dioxide. A cooling jacket was applied around the stirred cell to maintain the fluid at 2+/−5° C. Again, the stirrer was turned on and a pressure of 1000 psi was applied. The test was allowed to run until 119.7+/−0.1 g of a second permeate were produced. The fluid within the cell (the second concentrate) was mixed with the first concentrate to produce a final concentrate.

The final concentrate was then mixed with distilled water that had been force carbonated to contain 5 volumes of CO₂ at a ratio of 9:11 to produce a reconstituted beer. This level of carbonation of the distilled water was chosen to target roughly 2.5 volumes of CO₂ in the reconstituted beer. Distilled water was employed so that the reconstituted beer would best match the original beer in taste. This is important as beer drinkers place great importance on the water source from which the beer was made. By using water that is comprised of more than 99.999999% or more than 99.9999999% H₂O by weight, the reconstituted beer's taste will only be a function of the source water used in the brewing of the original beer and not of the water used to reconstitute the beer. As an alternative to distilled water, deionized water with a conductivity of less than 5 μS/cm or less than 1 μS/cm or less than 0.1 μS/cm could have been employed for reconstitution. As another alternative, well water, surface water or water from a municipal supply could have been employed so long as it had first been filtered by a single pass or two passes of nano-filtration or of reverse osmosis.

The reconstituted beer was submitted to a professional tasting panel, who noted that the aroma profile was substantially maintained though the reproduced beer had suffered from oxidation—likely due to inadvertent contact with air during the process. The effects of oxidation were less prominent, however, than in previous tests where the process temperature was above 2+/−5° C.—likely because of the slower rate of oxidation at lower temperatures.

The ethanol content of samples was determined using gas chromatography in conjunction with a mass spectrometer. Ion chromatogram results, benchmarked against a standard curve for ethanol concentration, indicated that the first concentrate, the second concentrate, the final concentrate and the second permeate contained 10.94+/−0.01, 3.57+/−0.02, 8.51+/−0.04 and 0.21+/−0.002 ABV. This implies that the ethanol passage of the overall process (the ratio of ethanol concentration in the second permeate to that in the initial feed) was 4.5% and the ethanol rejection of the overall process (unity minus the ethanol passage) was 95.5%. The high level of ethanol rejection was likely due to the low temperature at which the process was run, allowing ethanol diffusion through the membrane to be slowed.

### Example 3

This example describes how a filtration system in which a single filter is used to perform multiple filtration steps could be operated.

There are two significant challenges faced in continuous multi-pass multi-stage filtration systems. One challenge is dealing with the complexity of the filtration system as the number of filters increases. Another challenge is uneven fouling of the filtration media. Flux typically decreases from the retentate inlet to outlet in each filter because the increasing osmotic pressure reduces the net driving force. This can result in rapid fouling towards the entrances of filter retentates and slower fouling at the exits of filter retentates. A third challenge is the excessive energy consumption that results from the fact that the applied hydraulic pressure is dictated by the osmotic pressure at the exits of filter retentates, which is higher than the osmotic pressure at the entrances of filter retentates.

There are also two significant challenges faced in multi-pass batch filtration systems. One challenge relates to the large number of vessels required to store the permeate and retentate fluids during and at the end of each pass—particularly for processes with many passes. Another challenge is the mixing of streams with different minor component concentrations if the outlet from the retentate side of a filter is recirculated and mixed with fluid that serves as a feed to the inlet to the retentate side of the same filter. The mixing of a stream with a lower concentration of a minor component with a stream containing a higher concentration of the same minor component will result in increased diffusion of the minor component across the filtration medium into the permeate than if the two streams were to have undergone independent filtration processes.

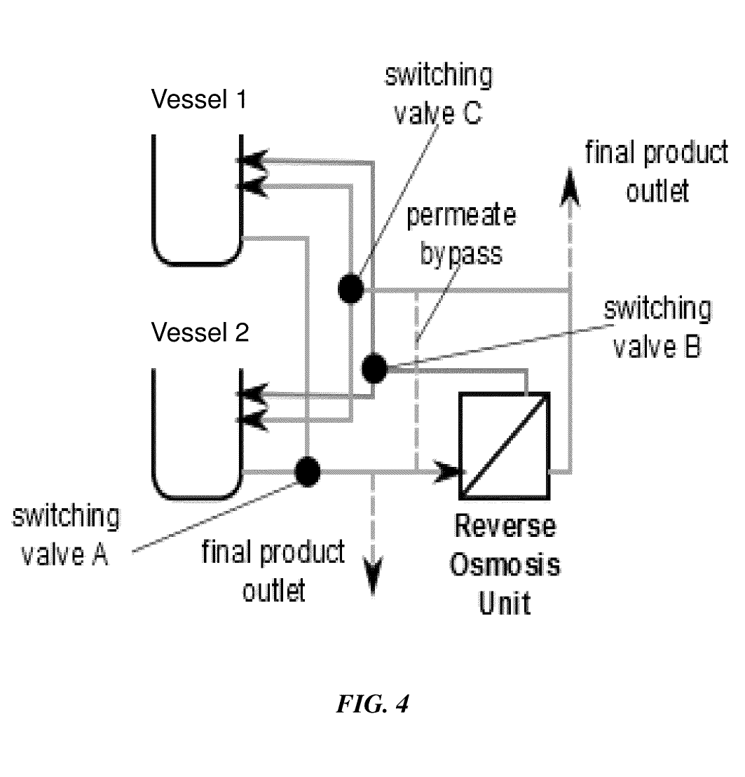

One remedy to these issues is the use of a batch filtration system in which the same filter (e.g., reverse osmosis unit) is used for multiple filtration passes and the mixing of streams with different minor component concentrations is avoided. FIG. 4 is an exemplary schematic illustration of one such system. The complexity of the system is reduced by employing only a single filter (or train of filters connected in parallel). Transport of liquid to the filter during the second filtration step (and subsequent filtration steps) can serve to at least partially clean the filtration medium after the first filtration step—thus reducing fouling. Hydraulic pressure may be increased with time as the osmotic pressure of the feed increases during each filtration step—thus allowing the time-averaged hydraulic pressure and energy consumption to be minimized. The number of vessels required is low—even if there are many passes of filtration. The mixing of streams with differing minor component concentrations is substantially eliminated by preventing mixing in the vessel to and from which the retentate is recirculated. A two-step filtration process for the concentration of ethanol in beer could proceed as follows. First, Vessel 1 would be filled with the beer to be fed to the filter. Valve A and Valve B could be opened to Vessel 1, and Valve C could be opened to Vessel 2. A first filtration step can be performed on the feed within Vessel 1, to produce an ethanol-concentrated retentate (which can be transported out of the system) and a water-concentrated permeate. The water-concentrated permeate from the first filtration step can be transported to Vessel 2. The retentate stream could be circulated between the retentate side of the filter and Vessel 1 until a desired concentration factor is reached, after which, the contents of Vessel 1 could be emptied through the final product outlet.

Valves A, B, and C could then be switched, and a second filtration step could begin on what was the permeate from the first filtration step. If there are to be only two filtration steps, then the second permeate could be exhausted continuously from the system via its final product outlet during the course of the second filtration step. Feed for the next batch could simultaneously be fed into Vessel 1. During the second filtration step, when the contents of Vessel 2 reach the desired concentration factor, the contents of Vessel 2 could be exhausted from the system and combined with the concentrate from the first filtration step to form a final concentrated product.

In some cases, as a way of performing a “split partial second pass,” liquid could be transported from one vessel to the other vessel for a period before the second filtration step begins.

To improve process efficiency, the system could be operated such that there is minimal mixing of the fluids in the vessels. Horizontal baffles may be installed in each vessel to prevent mixing of the fluids within the vessels. In some cases, as a filtration step process proceeds, the ethanol concentration of the permeate produced by the filter rises, since the rate of diffusion of ethanol through the filtration medium increases when the feed is at higher concentrations of ethanol. This permeate, higher in ethanol content, should, for reasons of buoyancy, naturally float upon the permeate within the vessel into which it is being channeled. Thus, a vertical ethanol concentration gradient could naturally be established. It may be beneficial to preserve this gradient for at least the following reasons. First, high purity permeate at the bottom of the vessel could be allowed to bypass subsequent filtration steps. Second, during subsequent filtration steps, an improved level of ethanol rejection and energy consumption could be achieved compared to the treatment of a mixed tank of fluid.

The pure batch process (with minimal mixing) described above is, in many cases, superior to semi batch processes where feed is recirculated within a sub-circuit that is lower in volume than the first vessel. The concentration in a semi-batch process generally rises approximately linearly with time. In a semi-batch process, feed solution is generally added at a constant rate into a recirculated loop. Disadvantageously, this means that, in certain cases, throughout the process, the feed stream is being mixed into a stream that is higher in concentration of ethanol, which reduces the overall efficiency of the system. On the other hand, in a batch process, the concentration of the entire batch is generally increased in time. In this scenario the increase in concentration is generally initially slow and increases to a higher rate toward the end. This means that, in certain cases, throughout substantially the entire process, the hydraulic pressure required and the rate of ethanol diffusion from the feed will generally be below that of a semi-batch process. Thus, the overall amount of energy required to run the batch process will be lower than the semi-batch process, in such cases. These energy savings depend, generally, upon the concentration factor of the feed stream, with higher concentration factors generally resulting in higher savings relative to a semi-batch process.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of concentrating a minor component of a mixture, comprising:
establishing a hydraulic pressure differential across a filtration medium within a filter receiving a liquid feed comprising a major component and a minor component to produce a first permeate enriched in the major component relative to the liquid feed and a first retentate enriched in the minor component relative to the liquid feed;
subsequently, separately from the first hydraulic pressure differential establishing step, transporting at least a portion of the first permeate to the filter; and
establishing a hydraulic pressure differential across the filtration medium within the filter receiving the portion of the first permeate to produce a second permeate enriched in the major component relative to the first permeate and a second retentate enriched in the minor component relative to the first permeate.

2. The method of claim 1, wherein:
the minor component is present within the first retentate at a weight percentage;
the minor component is present within the second retentate at a weight percentage; and
the lower of the weight percentage of the minor component in the first retentate and the weight percentage of the minor component in the second retentate is at least about 0.5 times the higher of the weight percentage of the minor component in the first retentate and the weight percentage of the minor component in the second retentate.

3-7. (canceled)

8. The method of claim 1, wherein
the minor component is present within the liquid feed at a weight percentage;
the minor component is present within the second retentate at a weight percentage; and
the lower of the weight percentage of the minor component in the liquid feed and the weight percentage of the minor component in the second retentate is at least about 0.5 times the higher of the weight percentage of the minor component in the liquid feed and the weight percentage of the minor component in the second retentate.

9-13. (canceled)

14. The method of claim 1, wherein, during and/or after the first hydraulic pressure differential establishing step and before the second hydraulic pressure differential establishing step, at least a portion of the first permeate is transported to a vessel.

15. The method of claim 14, wherein, after the first permeate has been transported to the vessel, the weight percentage of the minor component increases monotonically as a function of height within the vessel from a region containing the minor component at a first weight percentage to a region containing the minor component at a second weight percentage that is higher than the first weight percentage.

16. The method of claim 15, wherein the region containing the minor component at the first weight percentage is at or near the top of the permeate liquid in the vessel.

17. The method of claim 15, wherein the region containing the minor component at the first weight percentage is at or near the bottom of the permeate liquid in the vessel.

18. The method of claim 14, wherein the step of transporting at least a portion of the first permeate to the filter occurs after the step of transporting at least a portion of the first permeate from the filter to the vessel.

19. (canceled)

20. The method of claim 1, wherein the established hydraulic pressure differential results in a net driving pressure differential, and the net driving pressure differential is maintained at a substantially constant value as a function of time during a majority of time over which the hydraulic pressure differential is applied.

21. The method of claim 1, wherein the filtration medium comprises a filtration membrane.

22-24. (canceled)

25. The method of claim 1, wherein the major component is non-ionic and has a molecular weight of less than about 150 g/mol.

26. The method of claim 25, wherein the major component is water.

27. The method of claim 1, wherein the minor component is non-ionic and has a molecular weight of less than about 150 g/mol.

28. The method of claim 27, wherein the minor component is ethanol.

29. The method of claim 1, wherein the concentration of the minor component in the liquid feed is at least about 0.001% by weight.

30-33. (canceled)

34. The method of claim 1, wherein the rejection percentage of the minor component within the filter is between about 10% and about 95%.

35-36. (canceled)

37. The method of claim 1, wherein the rejection percentage of the minor component within the filter is between about 10% and about 99%.

38. The method of claim 14, wherein the vessel comprises a plurality of protrusions extending from an inner surface of the vessel into a bulk of the vessel.

39. A system for concentrating a minor component of a mixture, comprising:
a first vessel;
a second vessel;
a filter comprising a filtration medium defining a permeate side and a retentate side of the filter;
a fluidic pathway between the first vessel and the retentate side of the filter;
a fluidic pathway between the second vessel and the permeate side of the filter; and
a fluidic pathway between the second vessel and the retentate side of the filter.

40-77. (canceled)

78. A method of concentrating a minor component of a mixture, comprising:
establishing a hydraulic pressure differential across a filtration medium within a filter receiving a liquid feed comprising a major component and a minor component to produce a first permeate enriched in the major component relative to the liquid feed and a first retentate enriched in the minor component relative to the liquid feed; and
transporting at least a portion of the first retentate to a vessel, wherein the weight percentage of the minor component increases monotonically as a function of height within the vessel from a region containing the minor component at a first weight percentage to a region containing the minor component at a second weight percentage that is higher than the first weight percentage.

79-105. (canceled)
